(19) United States
(12) Patent Application Publication
(10) Pub. No.: US 2026/0292362 A1
(43) Pub. Date: Sep. 24, 2026

(54) IMAGING DEVICE AND METHOD OF OPERATING THE IMAGING DEVICE

(71) Applicant: SK hynix Inc., Icheon-si (KR)

(72) Inventors: Sang Hee PARK, Icheon-si (KR); Eun Khwang LEE, Icheon-si (KR)

(21) Appl. No.: 19/298,095

(22) Filed: Aug. 12, 2025

(30) Foreign Application Priority Data
Mar. 19, 2025 (KR) 10-2025-0035010

(51) Int. Cl. H04N 25/57; G06V 10/60; G06V 10/764

(52) U.S. Cl. CPC H04N 25/57; G06V 10/60; G06V 10/764

(57) ABSTRACT

An imaging device is provided to comprise: an imaging sensing unit comprising a first pixel and a second pixel that are configured to, in response to receiving an incident light, generate first image data and second image data, respectively, the second image data generated from the second pixel having a size smaller than a size of the first image data generated from the first pixel; and an image signal processor (ISP) configured to perform image processing on the first image data generated from the first pixel and the second image data generated from the second pixel, wherein the ISP is configured to composite the first image data and the second image data based on pixel information by coordinates, and a light intensity required for saturating the second pixel is greater than the light intensity required for saturating the first pixel.

### REFERENCE TO RELATED PATENT APPLICATION

This application claims priority to and the benefit of Korean Patent Application No. 10-2025-0035010, filed on Mar. 19, 2025, the disclosure of which is incorporated herein by reference in its entirety.

### TECHNICAL FIELD

Embodiments of the present disclosure relate to an imaging device and a method of operating the imaging device.

### BACKGROUND

With the development of the information and communication industry and the digitalization of electronic devices, image sensors with improved performance are being used in various fields such as digital cameras, camcorders, mobile phones, PCS (personal communication systems), game devices, security cameras, and medical micro cameras. In general, an image sensor has a pixel area including a photodiode and a peripheral circuit area. A unit pixel includes a photodiode and a transistor. The transistor is placed between the photodiode and a floating diffusion region to transfer charges generated by the photodiode to the floating diffusion region.

### SUMMARY

Various implementations of the disclosed technology provide an imaging device that has a high dynamic range by synthesizing image data generated from pixels having different sizes of image data.

Some implementations of the disclosed technology provide a method of operating an imaging device having a high dynamic range by the synthesizing image data generated from pixels having different sizes of image data.

In one aspect, an imaging device is provided to comprise: an imaging sensing unit comprising a first pixel and a second pixel that are configured to, in response to receiving an incident light, generate first image data and second image data, respectively, the second image data generated from the second pixel having a size smaller than a size of the first image data generated from the first pixel; and an image signal processor (ISP) configured to perform image processing on the first image data generated from the first pixel and the second image data generated from the second pixel, wherein the ISP is configured to composite the first image data and the second image data based on pixel information by coordinates, and a light intensity required for saturating the second pixel is greater than the light intensity required for saturating the first pixel.

In another aspect of the present disclosure, an imaging device is provided to comprise an image sensing unit comprising a first pixel configured to generate a first image data and a second pixel configured to generate a second image data having a size smaller than first image data of the first pixel; and an ISP (Image Signal Processor)) configured to process the first image data generated from the first pixel and the second image data generated from the second pixel, wherein each of the first pixel and the second pixel comprises a photoelectric conversion element configured to generate photocharges in response to an incident light, a transfer transistor electrically connected to the photoelectric conversion element, and a floating diffusion region connected to the transfer transistor and configured to store the photocharges transferred from the photoelectric conversion element by the transfer transistor.

In another aspect, a method of operating an imaging device is provided. The method comprises: capturing pixel images for a plurality of pixels in a wafer test; extracting image data of each of the plurality of pixels; generating pixel identification information for each pixel based on coordinates of the each pixel by distinguishing the plurality of pixels based on the image data of the plurality of pixels; and generating an HDR (High Dynamic Range) image based on the pixel identification information.

According to the embodiment of the present disclosure, the imaging may have a high dynamic range by synthesizing image data generated from pixels having different sizes of image data.

However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

FIG. 1 is an example diagram of an imaging system based on some implementations of the disclosed technology.

FIG. 2 is an example diagram of an image sensing unit shown in FIG. 1 based on some implementations of the disclosed technology.

FIG. 3 is an example of a circuit view of pixels of a pixel array shown in FIG. 1 based on some implementations of the disclosed technology.

FIG. 4 is an example of a graph showing a potential in each period of a bad pixel based on some implementations of the disclosed technology.

FIG. 5 is a view showing image data output from pixels based on some implementations of the disclosed technology.

FIG. 6 is an example of a graph showing the number of image data pixels of each of various pixel array samples based on some implementations of the disclosed technology.

FIG. 7 is an example of a graph showing the number of pixels for image data of one pixel array sample based on some implementations of the disclosed technology.

FIG. 8 is an example of a view showing image data of each of the first, second, and third pixels based on some implementations of the disclosed technology

FIG. 9 is an example of a graph showing image data over time based on some implementations of the disclosed technology.

FIG. 10 is an example of a graph showing the sensitivities of the first pixel, the second pixel, and the third pixel based on some implementations of the disclosed technology

FIG. 11 is an example of a graph showing a conversion gain based on some implementations of the disclosed technology.

FIG. 12 is an example of a view showing how to control the light irradiation time based on some implementations of the disclosed technology.

FIG. 13 is a graph showing that a high dynamic range is generated by synthesizing image data of each of the first pixel, the second pixel, and the third pixel of the imaging device based on some implementations of the disclosed technology.

FIG. 14 is an example of a flow chart illustrating a method of operating the imaging device based on some implementations of the disclosed technology

### DETAILED DESCRIPTION

Description will now be given in detail according to exemplary embodiments disclosed herein, with reference to the accompanying drawings.

For the sake of brief description with reference to the drawings, the same or equivalent components may be provided with the same reference numbers, and description thereof will not be repeated.

These terms are generally only used to distinguish one element from another. It will be understood that the terms “first” and “second” are used herein to describe various components but these components should not be limited by these terms. The above terms are used only to distinguish one component from another. For example, a first component may be referred to as a second component and vice versa without departing from the scope of the invention. The singular expressions include plural expressions unless the context clearly dictates otherwise.

Terms such as “comprise” or “comprising” are used herein and should be understood that they are intended to indicate an existence of several components, functions or steps, disclosed in the specification, and it is also understood that greater or fewer components, functions, or steps may likewise be utilized. However, the present disclosure may be embodied in various modified examples, and is not limited to embodiments described herein.

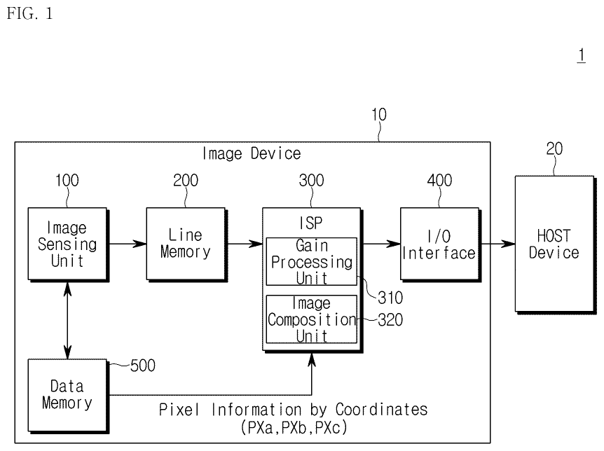

FIG. 1 is a block view showing an imaging system according to one embodiment.

Referring to FIG. 1, the imaging system 1 may refer to a device such as a digital still camera for photographing still images or a digital video camera for imaging moving images, as well as a device for detecting motion. For example, the imaging device 10 may be implemented as a digital single lens reflex (DSLR) camera, a mirrorless camera, or a mobile phone (particularly, a smartphone), but embodiments are not limited thereto. The imaging device 10 may be a concept that includes a device capable of imaging a subject and generating an image by including a lens and an imaging element.

The imaging system 1 may include an imaging device 10 and a host device 20.

The imaging device 10 may include an image sensing unit 100, a line memory 200, an image signal processor (ISP) 300, an input/output interface (I/O interface) 400, and a data memory 500.

In the example, the image sensing unit 100 may be CIS (Complementary Metal Oxide Semiconductor Image Sensor) configured to convert an optical signal into an electrical signal. The overall operation of the image sensing unit 100, including on/off, operation mode, operation timing, and sensitivity, can be controlled by the ISP 300. The sensitivity of a pixel in the image sensing unit 100 refers to its ability to convert incident light into an electrical signal. In the example, the amount of increase in image data over light exposure time in the pixel is based on the sensitivity of the pixel. The image sensing unit 100 can convert an optical signal into an electrical signal and transmit the image data to the line memory 200 based on the control of the ISP 300.

The line memory 200 may include volatile memory (e.g., DRAM, SRAM) and/or non-volatile memory (e.g., flash memory).

The line memory 200 can receive and store image data from the image sensing unit 100, and transmit the stored image data to the ISP 300 under the control of the ISP 300.

The ISP 300 can perform image signal processing on image data stored in the line memory 200. The ISP 300 can perform image signal processing for image data to reduce noise and improve image quality, such as gamma correction, color filter array interpolation, color matrix, color correction, color enhancement, and lens distortion correction.

To generate an HDR image, the ISP 300 may include a gain processing unit 310 and an image compositing unit 320.

The gain processing unit 310 may determine a gain to be operated on the image data (e.g., a multiplication operation).

The image synthesis unit 320 can synthesize an HDR image corresponding to a high dynamic range using image data generated from each of the first pixel PXa, the second pixel PXb, and the third pixel PXc.

In some implementations, the data memory 500 of the imaging device 10 according to one embodiment can transmit pixel information by coordinates to the ISP 300. The pixel information by coordinates may refer to the information related to individual pixels, indexed by their specific locations (coordinates). The pixel information by coordinates may include pixel identification information indicating whether a corresponding pixel belongs to the first pixel (PXa) group, the second pixel (PXb) group, or the third pixel (PXc) group. In one implementation, the pixel information by coordinates is generated immediately after a wafer test is completed and stored in the data memory 500. However, the embodiments of the disclosed technology are not limited thereto. For example, in another implementation, the pixel information by coordinates may be generated when the ISP 300 performs image processing on the captured subject in response to the capturing of a subject by the imaging device 10.

Pixel information by coordinates will be further described in detail later.

The ISP 300 can transmit image data (i.e., HDR image) processed by image signal to the input/output interface 400.

According to another embodiment, the gain processing unit 310 and the image compositing unit 320 for generating an HDR image may be included in the image sensing unit 100 rather than the ISP 300.

The input/output interface 400 performs communication with the host device 20 and can transmit image data processed by the image signal to the host device 20.

The host device 20 may be a processor (e.g., an application processor) that processes image data processed from a video signal received from the imaging device 10, a memory (e.g., a nonvolatile memory) that stores image data, or a display device (e.g., a liquid crystal display LCD) that visually outputs the image data.

The data memory 500 may store image data Data_PX in a digital format converted from an analog-to-digital converter 140.

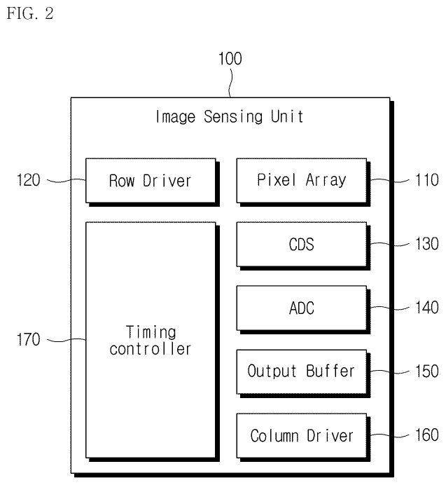

FIG. 2 is a view showing the image sensing unit shown in FIG. 1 in detail.

Referring to FIG. 2, the image sensing unit 100 may include a pixel array 110, a row driver 120, a correlated double sampler CDS 130, an analog-to-digital converter ADC 140, an output buffer 150, a column driver 160, and a timing controller 170. Here, each configuration of the image sensing unit 100 is merely exemplary, and at least some of the configurations may be added or omitted as needed.

The pixel array 110 may include a plurality of image pixels arranged in a plurality of rows and a plurality of columns. In one embodiment, the plurality of image pixels may be arranged in a two-dimensional pixel array including rows and columns. In another embodiment, the plurality of image pixels may be arranged in a three-dimensional pixel array. The plurality of image pixels may convert an optical signal into an electrical signal on a pixel-by-pixel basis or on a pixel-by-pixel-group basis, and the image pixels within a pixel-by-pixel-group may share at least certain internal circuitry. The pixel array 110 can receive a pixel control signal including a row selection signal, a pixel reset signal, and a transmission signal from the row driver 120, and a corresponding pixel of the pixel array 110 can be activated to perform an operation corresponding to the row selection signal, the pixel reset signal, and the transmission signal by the pixel control signal. Each of the image pixels generates a photocharge corresponding to the intensity (or illuminance) of incident light, and generates an electrical signal having a size corresponding to the amount of the generated photocharge, thereby detecting the incident light. For convenience of explanation, the image pixel may also be referred to as a pixel.

The row driver 120 can activate the pixel array 110 to perform specific operations on the pixels included in the row based on commands and control signals supplied by the timing controller 170.

In one embodiment, the correlated double sampler 130 may sequentially sample and hold a reference signal and an image signal provided to each of a plurality of column lines from the pixel array 110. That is, the correlated double sampler 130 can sample and hold levels of the reference signal and the image signal corresponding to each of the columns of the pixel array 110.

The correlated double sampler 130 can transmit the reference signal and image signal of each column to the ADC 140 as a correlated double sampling signal based on a control signal from the timing controller 170.

The ADC 140 may convert the correlated double sampling signal for each column output from the correlated double sampler 130 into a digital signal and output image data. In one embodiment, the ADC 140 can convert the correlated double sampling signal generated by the correlated double sampler 130 for each column into a digital signal and output it.

The ADC (140) may include a plurality of column counters corresponding to each column of the pixel array (110). Each column of the pixel array (110) is connected to each column counter, and image data may be generated by converting a correlated double sampling signal corresponding to each column into a digital signal using the column counters.

The output buffer 150 may temporarily hold and output image data of each column provided from the ADC 140. The output buffer 150 may temporarily store image data output from the ADC 140 based on a control signal of the timing controller 170.

The column driver 160 can select a column of the output buffer 150 based on a control signal of the timing controller 170 and control the output buffer 150 so that image data temporarily stored in the selected column of the output buffer 150 is sequentially output.

The timing controller 170 may control at least one of the row driver 120, the correlated double sampler 130, the ADC 140, the output buffer 150, and the column driver 160.

The timing controller 170 may provide clock signals required for the operation of each component of the image sensing unit 100, control signals for timing control, and address signals for selecting a row or column to at least one of the row driver 120, the correlated double sampler 130, the ADC 140, the output buffer 150, and the column driver 160. According to one embodiment, the timing controller 170 may include a logic control circuit, a phase lock loop PLL circuit, a timing control circuit, and a communication interface circuit.

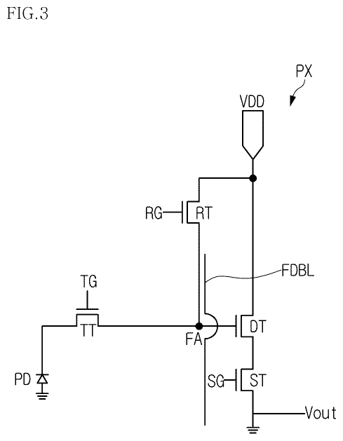

FIG. 3 is a circuit view of pixels of a pixel array shown in FIG. 1.

Referring to FIG. 3, the circuit diagram of the pixel may correspond to an equivalent circuit of each pixel PX included in the pixel array (see 110 of FIG. 3).

A pixel PX may include a photoelectric conversion element PD, a transfer transistor TT, a reset transistor RT, a floating diffusion region FA, a driver transistor DT, and a selection transistor ST. That is, the pixel may have a structure of a 4TR (4-transistor) pixel.

The photoelectric conversion element PD may generate and accumulate photocharges corresponding to the intensity of incident light. For example, the photoelectric conversion element PD can be implemented as a photodiode, a phototransistor, a photogate, a pinned photodiode, or a combination thereof. When the photoelectric conversion element PD is implemented as a photodiode, it can be a region doped with an impurity of a second conductivity type (e.g., N type) within a substrate having a first conductivity type (e.g., P type).

The transfer transistor TT may be connected between the photoelectric conversion element PD and the floating diffusion region FA. The transfer transistor TT can be turned on or off in response to a transfer control signal TX applied to the gate electrode TG, and the turned-on transfer transistor TT may transfer photocharges accumulated in the photoelectric conversion element PD to the floating diffusion region FA. A source electrode of the transfer transistor TT can be connected to the photoelectric conversion element PD, and a drain electrode can be connected to the floating diffusion region FA.

The reset transistor RT is connected between the power supply voltage VDD and the floating diffusion region FA, and can reset the voltage of the floating diffusion region FA to the power supply voltage VDD in response to a reset control signal RX applied to the gate electrode RG. The power supply voltage VDD may be applied to a source electrode of the reset transistor RT, and a drain electrode may be connected to the floating diffusion region FA.

The floating diffusion region FA may accumulate photocharges transferred from the transfer transistor TT. For example, the floating diffusion region FA can be a region doped with an impurity of a second conductivity type (e.g., N type) within a substrate having a first conductivity type (e.g., P type), and the substrate and the impurity doped region may be modeled as a junction capacitor. The floating diffusion region FA may be connected to a gate electrode of the driver transistor DT, a drain electrode of the transfer transistor TT, and a drain region of the reset transistor RT. A floating diffusion electrode can be arranged in the floating diffusion region FA.

The driver transistor DT is connected between the power supply voltage VDD and the selection transistor ST, and can amplify the change in the electric potential of the floating diffusion region FA that receives the photocharge accumulated in the photoelectric conversion element PD and transfer it to the selection transistor ST. The gate electrode of the driver transistor DT is connected to the floating diffusion region FA, the power supply voltage VDD is applied to the source electrode (or drain electrode), and the drain electrode (or source electrode) may be connected to the source electrode of the selection transistor ST.

The selection transistor ST is connected between the driver transistor DT and the output signal line (or column line), and is turned on by a row selection control signal SX applied to the gate electrode SG to output an electrical signal transmitted from the driver transistor DT as a pixel signal Vout. The source electrode of the selection transistor ST can be connected to the drain electrode (or source electrode) of the driver transistor DT.

The voltage of the floating diffusion region FA may be determined by the amount of photocharge transferred through the transfer transistor TT, and the voltage of the floating diffusion region FA can be lowered as the amount of photocharge increases.

The floating diffusion region FA (or floating diffusion electrode) may form a capacitance with the boosting control line FDBL.

Each of the control signals provided to the transmission control signal TX, the reset control signal RX, the row selection control signal SX, and the boosting control line FDBL may be supplied from the row driver 120, but the embodiments are not limited thereto.

The pixel PX according to the present specification may include first to fourth periods T1 to T4. Hereinafter, for convenience of explanation, the reset period is referred to as the first period T1, the light irradiation period is referred to as the second period T2, and the lead period is referred to as the third and fourth periods T3 and T4. The third period T3 may be an FD reset period, and the fourth period T4 may be a lead-out period. The first period T1 may be a PD reset period.

In the below, the potential change of the cold pixel (or bad pixel) according to the first to fourth periods T1 to T4, which have been described above, will be further described. The cold pixel or the bad pixel refer to a defective pixel.

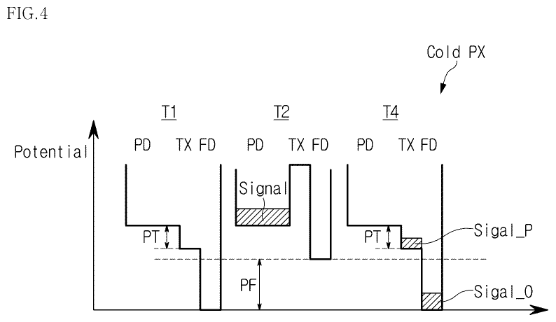

FIG. 4 is a view showing a potential in each period of a bad pixel.

Referring to FIG. 4, in the first period T1, the photocharges of the photoelectric conversion element PD may be completely reset.

In the second period T2, the photocharges (Signal) may be accumulated in the photoelectric conversion element PD.

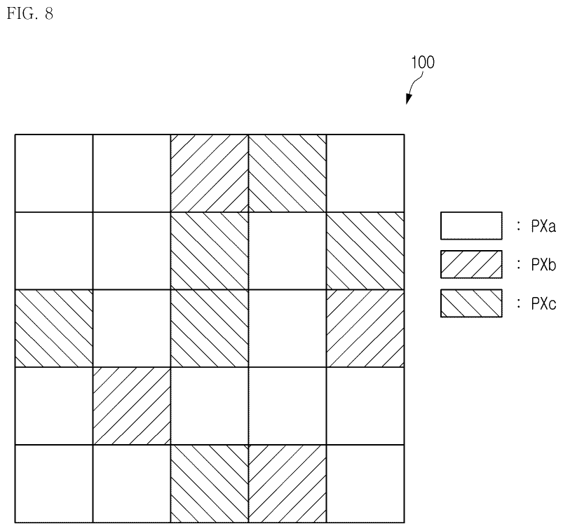

In the fourth period T4, when the transfer transistor TT is turned on, the photocharges (Signal) accumulated in the photoelectric conversion element PD in the second period T2 may move to the floating diffusion region FA. However, since the pixel according to FIG. 8 is a cold pixel, Cold PX (or bad pixel), only some of the photocharges (Signal_O) accumulated in the photoelectric conversion element PD may be accumulated in the floating diffusion region FA, and the remaining photocharges (Signal_P) may not be accumulated in the photoelectric conversion element PD. Thus, when the same light is received by each of a cold pixel and a normal pixel, the image data generated from the cold pixel Cold PX may be smaller than the image data generated from the normal pixel Normal PX.

For example, a cold pixel, Cold PX, may be a pixel in which some of the photocharges (Signal) accumulated in the photoelectric conversion element PD leak to the transfer transistor TT due to a defect in the transfer transistor TT in the fourth period T4. However, other implementations are also possible, and the embodiments are not limited thereto.

In the case of a normal pixel, the same amount of photocharge (Signal) as the photocharge Signal accumulated in the photoelectric conversion element PD can be accumulated in the floating diffusion area FA.

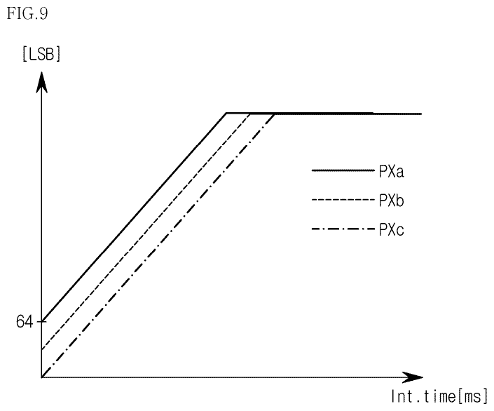

FIG. 9 is a view showing that image data output from pixels according to one embodiment is stored.

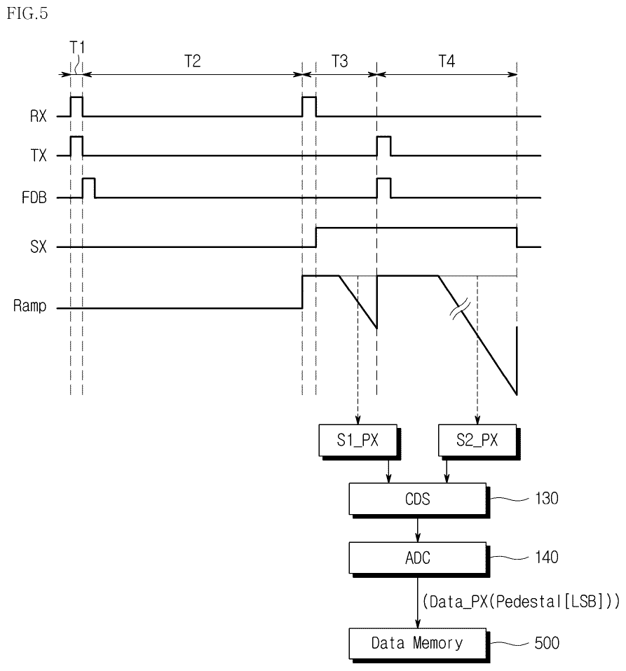

FIG. 5 is a drawing explaining storing pixel signals S1_PX and S2_PX extracted (or generated) from the third period T3 and the fourth period T4 of the pixel PX in the data memory 500.

Referring to FIG. 5, a first pixel signal S1_PX may be output to an output signal line in a third period T3, and a second pixel signal S2_PX may be output to an output signal line in a fourth period T4. The output pixel signals S1_PX and S2_PX are transmitted to the correlated double sampler 130.

The process of storing pixel signals S1_PX and S2_PX extracted (or generated) from the third period T3 and the fourth period T4 of the pixel PX shown in FIG. 5 in the data memory 500 can be performed in the wafer test stage.

In some implementations, the generation of pixel signals S1_PX and S2_PX may be performed in a white environment. The white environment refers to a condition where the image sensing unit is exposed to a uniform, bright, and typically spectrally neutral (white) light source. However, the present embodiments are not limited thereto. In other implementations, the generation of pixel signals S1_PX and S2_PX may be performed in a black environment. The black environment refers to a controlled testing or operating condition where the image sensing unit is placed in complete or near-complete darkness. When the generation of pixel signals S1_PX and S2_PX is performed in a black environment, there may be no photocharge accumulated in the photoelectric conversion element PD in the second period T2.

For example, in the case of a normal pixel Normal PX, the first pixel signal S1_PX may be a first voltage value, and the second pixel signal S2_PX may be a second voltage value. The difference between the first voltage value and the second voltage value may correspond to the amount of photocharge applied to the photoelectric conversion element PD.

The correlated double sampler 130 may calculate the difference between the transmitted pixel signals S1_PX and S2_PX and provide it to the ADC 140. Accordingly, the ADC 140 may receive a voltage value corresponding to the difference between the first voltage value and the second voltage value and perform digital conversion and offset. For example, the ADC 140 may digitally convert and offset a voltage value corresponding to the difference between the first voltage value and the second voltage value provided from the correlated double sampler 130 to generate image data Data_PX(Pedestal[LSB]), the value of which may be 64 [LSB]. For example, it is assumed that the image data[LSB] generated from a normal pixel is set to 64 [LSB]. The LSB may mean “least significant bit” and such LSB may be used a unit for a digital output of a pixel.

However, in the case of a cold pixel Cold PX, the first pixel signal S1_PX may have a first voltage value, and the second pixel signal S2_PX may have a voltage (e.g., a third voltage value) lower than the second voltage value. The correlated double sampler 130 calculates the difference between the transmitted pixel signals (S1_PX, S2_PX) and provides it to the ADC (140). Accordingly, the ADC (140) may receive a voltage value corresponding to the difference between the first voltage value and the third voltage value, and perform digital conversion and offset. For example, the ADC 140 may digitally convert and offset a voltage value corresponding to the difference between the first voltage value and the second voltage value provided from the correlated double sampler 130 to generate image data Data_PX(Pedestal[LSB]), the value of which may be 64 [LSB]. For example, it is assumed that the image data[LSB] generated from a normal pixel is set to 64 [LSB].

According to the present embodiment, as described above, the size of the image data Data_PX generated from each pixel PX is different based on the normal pixel and the cold pixel, and the image data Data_PX generated for each pixel PX may be stored in the data memory 500. The data memory 500 can store the image data Data_PX so as to correspond to the pixels PX for each coordinate.

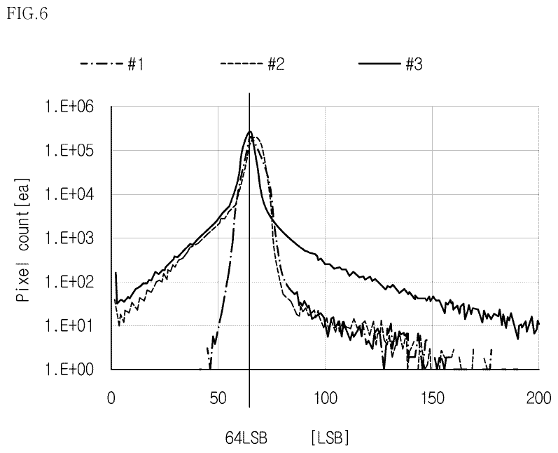

FIG. 6 is a graph showing the number of image data pixels of each of various pixel array samples.

FIG. 6 shows the image data Data_PX values generated for each pixel PX described above in FIG. 5 in the first pixel array sample #1, the second pixel array sample #2, and the third pixel array sample #3, and the number of pixels PX corresponding to the corresponding values.

Referring to FIG. 6, for the first pixel array sample #1, the image data Data_PX of most pixels PX may be greater than 50 [LSB], and for the second and third pixel array samples #2 and #3, the image data Data_PX of a plurality of pixels PX are between 0 and 50 [LSB].

For the first pixel array sample #1, there are not many pixels PX smaller than 50 [LSB], so it may not contain many cold pixels.

On the other hand, for the first and second pixel array samples #2 and #3, there are some pixels (PX) smaller than 50 [LSB], so they may contain a large number of cold pixels.

However, the cold pixel may not have an exact numerical value or standard, and may be determined based on [LSB] as needed.

In addition, by analyzing the image data Data_PX generated for each pixel PX of these pixel array samples #1 to #3, it is possible to distinguish a pixel array capable of generating an HDR image corresponding to a high dynamic range by compositing the image data generated from each of the normal pixels and the cold pixels. That is, the first pixel array sample #1 may have a very small number of cold pixels, and in this case, it may not be applicable to generating an HDR image corresponding to a high dynamic range by compositing image data generated from each of normal pixels and cold pixels.

Below, it will be explained how to distinguish between cold pixels and normal pixels based on the third pixel array sample #3, for example.

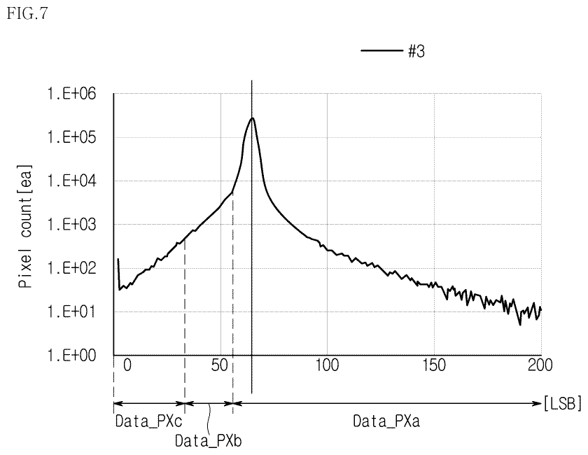

FIG. 7 is a graph showing the number of pixels for image data generated from pixels of one pixel array sample.

Referring to FIG. 7, for the third pixel array sample #3 (or the pixel array according to one embodiment), image data generated by the pixels in the third pixel array sample #3 may be divided into multiple sections having different brightness from one another. In the example as shown in FIG. 7, the image data generated by the pixels in the third pixel array sample #3 may be divided into three sections which include first image data Data_Pxa of about 50 [LSB] or more, second image data Data_PXb between about 30 [LSB] and about 50 [LSB], and third image data Data_PXc of less than about 30 [LSB]. However, the numerical value that divides the image data of FIG. 7 into three sections is not limited thereto and may be changed in various ways as needed.

FIG. 8 is a view showing image data of each of the first, second, and third pixels.

Referring to FIG. 8, a pixel having the first image data Data_PXa distinguished in FIG. 7 is defined as a first pixel PXa, a pixel having the second image data Data_PXb is defined as a second pixel PXb, and a pixel having the third image data Data_PXc is defined as a third pixel PXc.

FIG. 8 shows an example of the arrangement of the first pixel PXa, the second pixel PXb, and the third pixel PXc of the image sensing unit 100. However, the arrangement and number of pixels PXa, PXb, and PXc shown in FIG. 8 are not limited thereto.

The image sensing unit 100 according to one embodiment may generate an image with a high dynamic range HDR by compositing image data generated from pixels PXa, PXb, and PXc having different image data Data_PXa, Data_PXb, and Data_PXc.

FIG. 9 is a graph showing image data over time according to one embodiment.

Referring to FIG. 9, it is shown that the change [LSB] of image data Data_PXa, Data_PXb, and Data_PXc generated from each of the first to third pixels PXa, PXb, and PXc according to the light irradiation time Int. time.

As shown in FIG. 9, the amount of change in image data Data_PXa, Data_PXb, and Data_PXc generated from each of the first to third pixels PXa, PXb, and PXc according to the light irradiation time Int. time may be the same. That is, the sensitivities of the first to third pixels PXa, PXb, and PXc may be the same.

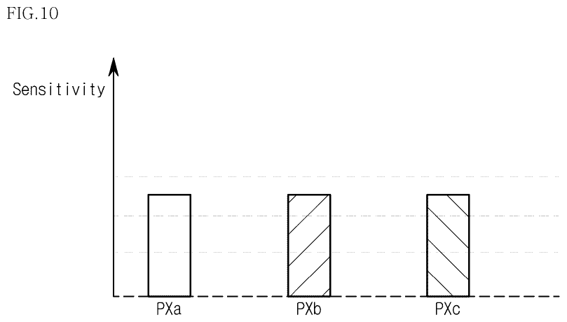

FIG. 10 is a graph showing the sensitivities of the first pixel, the second pixel, and the third pixel according to one embodiment.

Referring to FIG. 10, as described in FIG. 9, the sensitivities of the first to third pixels PXa, PXb, and PXc may be the same.

The reason why the sensitivities of the first to third pixels PXa, PXb, and PXc are the same will be explained below.

As described above, when the same light is received by each of a cold pixel and a normal pixel, the image data generated from the cold pixel Cold PX may be smaller than the image data generated from the normal pixel Normal PX. For example, in the cold pixel Cold PX, due to a defect in the transfer transistor, some of the photocharges (Signal) accumulated in the photoelectric conversion element PD may leak to the transfer transistor in the fourth period T4. Here, the photocharge leaking into the transfer transistor can be fixed for each cold pixel, and the size of the generated image data Data_PX varies based on the photocharge leaking. That is, in the case of the cold pixel, except for the photocharge leaking into the transfer transistor, the remaining photocharge (Signal) moves to the floating diffusion area FA.

Therefore, in the case of the first to third pixels PXa, PXb, and PXc of FIG. 10, only the size of the initial image data Data_PXa, Data_PXb, and Data_PXc is different, and the sensitivity can be the same.

The data memory (see 500 of FIG. 1) of the imaging device (see 10 of FIG. 1) according to one embodiment may transmit pixel information by coordinates to the ISP (see 300 of FIG. 1). The pixel information by coordinates may be immediately after the wafer test described above is completed, but the embodiments are not limited thereto, and may be when a user photographs a subject using the imaging device (see 10 of FIG. 1) and the ISP (see 300 of FIG. 1) performs image processing on the photographed subject.

Pixel Information by Coordinates may be information about the classification of pixels (PX) by coordinates (first to third pixels PXa, PXb, and PXc).

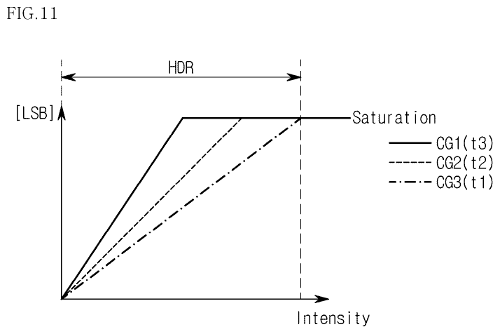

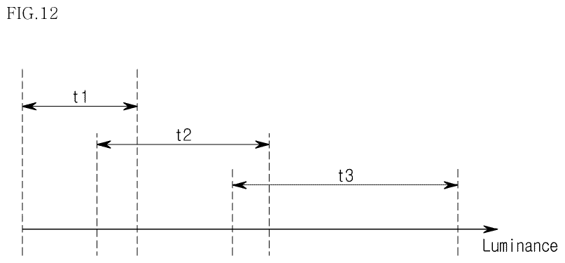

FIG. 11 is an example of a graph showing the generation of a high dynamic range image by adjusting the conversion gain. FIG. 12 is an example of a diagram showing the adjustment of the light exposure time.

The horizontal axis of FIG. 11 represents light intensity, and the vertical axis represents image data Data_PX [LSB]. The horizontal axis of FIG. 12 may represent luminance (or light intensity).

FIGS. 11 and 12 show that high dynamic range images can be generated by controlling conversion gain and exposure time together.

Referring to FIG. 11, for example, modes having three conversion gains CG1, CG2, and CG3 are shown. The first conversion gain CG1 may be the largest, the third conversion gain CG3 may be the smallest, and the second conversion gain CG2 may be between the first conversion gain CG1 and the third conversion gain CG3.

The gain processing unit (see 310 in FIG. 1) may determine the gain based on the difference between different conversion gains CG1, CG2, and CG3 and provide it to the image synthesis unit (see 320 in FIG. 1). The gain based on the difference in conversion gain may be experimentally determined in advance and stored in the gain processing unit 310.

It can be said that the slopes of image data with respect to illuminance (or light intensity) are different in the first conversion gain CG1 mode, the second conversion gain CG2 mode, and the third conversion gain CG3 mode.

The first conversion gain CG1 mode can operate in a third exposure environment t3 with the longest exposure time t3, the second conversion gain CG2 mode can operate in a second exposure environment t2 with an intermediate exposure time t2 shorter than t3, and the third conversion gain CG3 mode can operate in a first exposure environment t1 with the shortest exposure time t1 less than t2.

In addition, the imaging device may take multiple shots so that the light exposure time is the shortest in the image capture in the first exposure environment t1, the light exposure time is the next shortest or intermediate in the image capture in the second exposure environment t2, and the light exposure time is the longest in the image capture in the third exposure environment t3.

Assume that the image subject includes three parts having different brightness from one another, which includes the brightest part, the mid-tone or next brighter part, the darkest part. Since the first exposure environment t1 has the shortest light exposure time, the imaging device can generate an image of the brightest part of the imaging subject by using the shortest exposure time t1 in the first exposure environment t1 so that the imaging device may generate image data of the brightest part in the third conversion gain CG3 mode of FIG. 11.

Since the second exposure environment t2 has a longer light exposure time t2 relative to the shortest exposure time t1, the imaging device may generate an image of the next brighter part of the imaging subject by using the light exposure time t2. Therefore, in the second exposure environment t2, the imaging device may generate image data of the next brighter or mid-tone part in the second conversion gain CG2 mode of FIG. 11.

Since the third exposure environment t3 has the longest light exposure time t3, the imaging device may operate using the exposure time t3 to generate an image of the darkest part of the imaging subject. Therefore, in the third exposure environment t3, the imaging device may generate image data of the darkest part in the first conversion gain CG1 mode of FIG. 11.

The image synthesis unit (see 320 in FIG. 1) may perform compositing of HDR image corresponding to a high dynamic range using image data of pixels operating in each of the first conversion gain CG1 mode, the second conversion gain CG2 mode, and the third conversion gain CG3 mode.

Thus, in FIGS. 11 and 12, since an image in the high-resolution range is generated using the conversion gains CG1, CG2, and CG3, it might be necessary to change multiple modes or capture multiple shots.

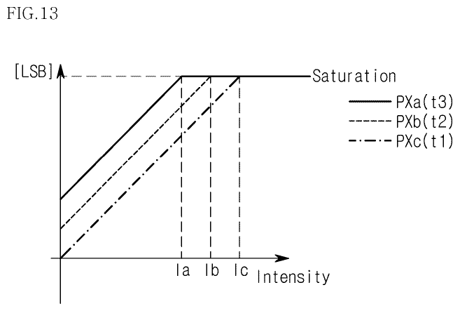

FIG. 13 is a graph showing that a high dynamic range is generated by compositing image data of each of the first pixel, the second pixel, and the third pixel of the imaging device according to one embodiment.

FIG. 13 shows the change in image data [LSB] according to the intensity (or illuminance) of light of each of the first pixel PXa, the second pixel PXb, and the third pixel PXc. When initially irradiated with light of the spatially uniform light intensity over the different pixels at different pixel locations within the pixel array, the image data value of the different pixels may vary from pixel to pixel due to physical variations in pixels. For example, the pixels in a pixel array can be classified into three types of pixels exhibiting three different levels of photosensitivity in response to the same input light intensity: the first pixel PXa may produce the largest pixel output, followed by the second pixel PXb producing an intermediate pixel output, and then the third pixel PXc producing the smallest pixel output.

Based on the known levels of the photosensitivity and corresponding locations of the pixels in the pixel array, the image compositing unit (see 320 in FIG. 1) can composite an HDR image corresponding to a high dynamic range using image data of each of the first pixel PXa, the second pixel PXb, and the third pixel PXc.

In the image sensing device, each pixel has a physical limit to the amount of electrical charge it can hold and when the amount of light hitting a pixel causes it to generate more charge than its charge holding limit, the pixel is referred to as being saturated. The light intensity required for saturating the third pixel PXc (see Data_PXc in FIG. 7) may be greater than the light intensity required for saturating the second pixel PXb (see Data_PXb in FIG. 7), and the light intensity required for saturating the second pixel PXb (see Data_PXb in FIG. 7) may be greater than the light intensity required for saturating the first pixel PXa (see Data_PXa in FIG. 7).

An image with a high dynamic range (HDR Image) can be generated by compositing image data Data_PXa generated from a first pixel PXa, image data Data_PXb generated from a second pixel PXb, and image data Data_PXc generated from a third pixel PXc. While various HDR imaging methods use different modes for capturing images with different exposure times at all pixels in a pixel array as illustrated in FIGS. 11 and 12, the technology disclosed in this patent document operates the pixel array with one desired exposure time without capturing different images with different exposure times to capture incident light and uses the measured levels of the photosensitivity and corresponding locations of the pixels in the pixel array to generate a HDR image. Specifically, pixel signals from pixels in the pixel array can be selected based on their pre-measured levels of the photosensitivity and corresponding locations of the pixels in the pixel array to compose or composite the final HDR image. For example, the image data Data_PXa generated from the first pixel PXa can replace image data generated in the first exposure environment t1 in other HDR techniques described above in FIGS. 11 and 12, the image data Data_PXb generated from the second pixel PXb can replace image data generated in the second exposure environment t2 in other HDR techniques described above in FIGS. 11 and 12, and the image data Data_PXc generated from the third pixel PXc can replace image data generated in the third exposure environment t3 in other HDR techniques described above in FIGS. 11 and 12.

According to one embodiment, the image data Data_PXa generated from a first pixel PXa, image data Data_PXb generated from the second pixel PXb, and the image data Data_PXc generated from the third pixel PXc are composited to generate a high dynamic range image (HDR Image), so that an image can be generated with a single shooting with a desired exposure time without taking multiple shots with different exposure times. In the implementations, image data Data_PXa, Data_PXb, and Data_PXc can be captured or generated simultaneously.

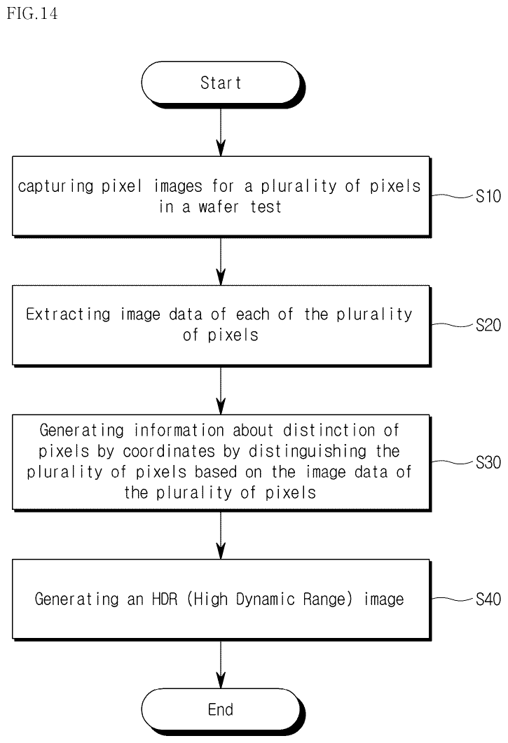

FIG. 14 is a flow chart illustrating a method of operating the imaging device according to one embodiment. The operating method of the imaging device described in FIG. 14 relates to the operating method of the imaging device described above with reference to FIGS. 1 to 13. Therefore, when describing the operating method with reference to FIG. 14, FIGS. 1 to 13 may be referred to together, and repeated description of parts already described in FIGS. 1 to 13 will be omitted.

Referring to FIG. 14, the operating method of the imaging device according to one embodiment may include a step S10 of capturing pixel images for a plurality of pixels in a wafer test. In the step S10, as described above in FIG. 5, the wafer test can be performed in a white environment using spatially uniform light illumination of the different pixels or a black environment to obtain the corresponding pixel output signals.

Next, the operating method of the imaging device according to one embodiment includes a step S20 of extracting image data of each of the plurality of pixels.

Next, the operating method of the imaging device according to one embodiment includes a step S30 of generating pixel identification information for each pixel by coordinates. Thus, the pixel identification information is related to individual pixels, indexed by their coordinates. In the implementation, the pixel identification information indicates whether a corresponding pixel belongs to the first pixel (PXa) group with the lowest level of photosensitivity that corresponds to the longest exposure time t3, the second pixel (PXb) group with the intermediate level of photosensitivity that corresponds to the intermediate exposure time t2 shorter than the exposure time t3, or the third pixel (PXc) group with the highest level of photosensitivity that corresponds to the shortest exposure time t1 shorter than the exposure time t2. Such pixel identification information may be generated by distinguishing the plurality of pixels based on image data of the plurality of pixels. For example, as described above in FIG. 7, in case that the image data is generated from the pixels in the third pixel array sample #3 (or the pixel array according to one embodiment), the image data can include three sections with different brightness from one another. For example, image data generated from the pixels PX of the third pixel array sample #3 includes first image data Data_Pxa of about 50 [LSB] or more, second image data Data_PXb between about 30 [LSB] and about 50 [LSB], and third image data Data_PXc of less than about 30 [LSB], and the pixels in the third pixel array sample #3 may be identified or classified as one of the first pixel PXa, the second pixel PXb, or the third pixel PXc which correspond to pixels having the first image data Data_PXa, pixels having the second image data Data_PXb, and pixels having the third image data Data_PXc, respectively. Thus, in the example,

Next, the operating method of the imaging device according to one embodiment includes a step S40 of generating an HDR image. The image compositing unit (see 320 of FIG. 1) of the ISP (see 300 of FIG. 1) can composite an HDR image corresponding to a high dynamic range using image data of each of the first pixel PXa, the second pixel PXb, and the third pixel PXc ). A detailed description of the step S40 is omitted as it has been described above with reference to FIG. 13.

Although various implementations have been described with reference to the exemplified drawings, variations and improvements of the disclosed embodiments and other embodiments may be made based on what is described or illustrated in this document.

1. An imaging device, comprising:
an imaging sensing unit comprising a first pixel and a second pixel that are configured to, in response to receiving an incident light, generate first image data and second image data, respectively, the second image data generated from the second pixel having a size smaller than a size of the first image data generated from the first pixel; and
an image signal processor (ISP) configured to perform image processing on the first image data generated from the first pixel and the second image data generated from the second pixel,
wherein the ISP is configured to composite the first image data and the second image data based on pixel information by coordinates, and a light intensity required for saturating the second pixel is greater than the light intensity required for saturating the first pixel.

2. The imaging device of claim 1, wherein a sensitivity of the first pixel is same as a sensitivity of the second pixel.

3. The imaging device of claim 2, wherein amounts of increase in the first image data and the second image data over light exposure time are based on the sensitivity of the first pixel and the second pixel, respectively.

4. The imaging device of claim 1, wherein upon an initial irradiation of the incident light, the second image data is smaller than the first image data.

5. The imaging device of claim 1, further comprising:
a data memory configured to store the pixel information by coordinate and transmit the pixel information by coordinates to the ISP wherein the pixel information by coordinates includes pixel identification information indicating whether a corresponding pixel belongs to the first pixel or the second pixel.

6. The imaging device of claim 5, wherein the pixel identification information is determined based on pixel images obtained in a black environment or a white environment.

7. The imaging device of claim 1, wherein the first image data and the second image data are obtained simultaneously.

8. The imaging device of claim 7, wherein the ISP comprises an image compositing unit configured to composite the first image data and the second image data.

9. The imaging device of claim 1, wherein the pixel array further comprises a third pixel configured to generate third image data having a size smaller than the second image data, and a sensitivity of the third pixel is same as a sensitivity of the second pixel.

10. The imaging device of claim 9, wherein upon an initial irradiation of the incident light, the third image data is smaller than the second image data.

11. The imaging device of claim 10, wherein the first image data, the second image data, and the third image data are obtained simultaneously.

12. An imaging device, comprising:
an image sensing unit comprising a first pixel configured to generate a first image data and a second pixel configured to generate a second image data having a size smaller than first image data of the first pixel; and
an ISP (Image Signal Processor)) configured to process the first image data generated from the first pixel and the second image data generated from the second pixel,
wherein each of the first pixel and the second pixel comprises a photoelectric conversion element configured to generate photocharges in response to an incident light, a transfer transistor electrically connected to the photoelectric conversion element, and a floating diffusion region connected to the transfer transistor and configured to store the photocharges transferred from the photoelectric conversion element by the transfer transistor.

13. The imaging device of claim 12, wherein during a read-out period, the photocharges accumulated in the photoelectric conversion element of the second pixel leak to the transfer transistor of the second pixel.

14. The imaging device of claim 13, wherein after the read-out period, the photocharges accumulated in the floating diffusion region of the second pixel are smaller than photocharges accumulated in the floating diffusion region of the first pixel.

15. A method of operating an imaging device, comprising:
capturing pixel images for a plurality of pixels in a wafer test;
extracting image data of each of the plurality of pixels;
generating pixel identification information for each pixel based on coordinates of the each pixel by distinguishing the plurality of pixels based on the image data of the plurality of pixels; and
generating an HDR (High Dynamic Range) image based on the pixel identification information.

16. The method of claim 15, wherein the generating of the pixel identification information includes classifying the plurality of pixels into a first pixel group including a first pixel configured to generate a first image data and or a second pixel group including a second pixel configured to generate a second image data having a size smaller than the first image data.

17. The method of claim 15, wherein a sensitivity of the plurality of pixels is same, and amounts of increase in the image data over light irradiation time are based on the sensitivity of the plurality of pixels.

18. The method of claim 15, further comprising: storing the pixel identification information in a data memory, and providing the pixel identification information from the data memory to an ISP (Image signal Processor).

19. The method of claim 18, wherein the ISP is configured to generate the HDR image based on the pixel identification information.
